(19) United States
(12) Patent Application Publication
(10) Pub. No.: US 2012/0086682 A1
(43) Pub. Date: Apr. 12, 2012

(54) DRIVING APPARATUS AND DRIVING METHOD

(75) Inventor: Zhe SHI, Beijing (CN)

(73) Assignee: BEIJING BOE OPTOELECTRONICS TECHNOLOGY CO., LTD., Beijing (CN)

(21) Appl. No.: 13/270,412

(22) Filed: Oct. 11, 2011

(30) Foreign Application Priority Data
Oct. 12, 2010 (CN) 201010512068.X

(51) Int. Cl. G09G 3/36; G09G 5/00

(52) U.S. Cl. 345/204; 345/87

(57) ABSTRACT

A driving apparatus is provided and comprises a gate driver, a data driver, a gate line driving module array and/or a data line driving module array. The gate line driving module array comprises “A” gate line driving modules, each connected to one output terminal of the gate driver and two gate lines, the gate line driving module being used for driving the gate lines connected therewith to be sequentially turned on, where 1≦A≦M/2, A is an integral number, and M represents a total number of rows of the gate lines. A driving method for display is also provided.

### TECHNICAL FIELD

Embodiments of the disclosed technology relates to a driving apparatus for a display and a driving method therefor.

### BACKGROUND

Liquid crystal displays (LCDs) have characteristics of small volume, low power consumption, no radiation and the like, and have occupied a dominant place in the field of flat panel display.

The main structure of a liquid crystal display includes an array substrate and a color-filter substrate assembled together, with a liquid crystal layer sandwiched therebetween. On the array substrate, there are formed gate lines for providing scanning signals, data lines for providing data signals, pixel electrodes for pixel points, and common electrode lines for providing a common voltage. On the color-filter substrate, there are formed a black matrix and colorful resins. Of the above, the gate lines are driven by a gate driver constituted by gate driving integrated circuits (“IC”). Each of the gate driving ICs has a plurality of output terminals, and signals outputted from each of the output terminals correspondingly drive one gate line. Data lines are driven by a data driver constituted by data driving ICs. Each of the data driving ICs has a plurality of output terminals, and signals outputted from each of the output terminals correspondingly drive one data line.

### SUMMARY

In one embodiment of the disclosed technology, there is disclosed a driving apparatus for a display, and the apparatus comprises: a gate driver; a data driver; and a gate line driving module array and/or a data line driving module array, wherein the gate line driving module array comprises “A” gate line driving modules, each connected to one output terminal of the gate driver and two gate lines and adapted for driving the gate lines connected therewith to sequentially turn on, where 1≦A≦M/2, is an integral number, and M represents a total number of rows of the gate lines.

In another embodiment of the disclosed technology, there is disclosed a liquid crystal display comprising the above driving apparatus.

In a further embodiment of the disclosed technology, there is disclosed a driving method for a display, and the method comprises: dividing data lines of the display into a plurality of groups with every two data line being in one group; during a first time period when each of the gate lines is turned on, one of the two data lines in each of the groups of data lines are turned on simultaneously; and during a second time period when each of the gate lines is turned on, the other one of the two data lines in each of the groups of data lines are turned on simultaneously.

Further scope of applicability of the disclosed technology will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

To illustrate the technical solutions for embodiments of the disclosed technology or related arts more clearly, a brief introduction will be made to the accompanying drawings to be used for description of the embodiments. Obviously, the accompanying drawings to be described below are only a part of the embodiments. To those skilled in the art, other drawings can be obtained from these drawings without making creative work.

FIG. 1 is a structural diagram for a driving apparatus of a liquid crystal display according to a first embodiment of the disclosed technology;

FIG. 2 is a timing chart for driving according to the first embodiment of the disclosed technology.

FIG. 3 is a structural diagram for the driving apparatus of the liquid crystal display according to a second embodiment of the disclosed technology;

FIG. 4 is a timing chart for driving according to the second embodiment of the disclosed technology;

FIG. 5 is a structural diagram for the driving apparatus of the liquid crystal display according to a third embodiment of the disclosed technology;

FIG. 6 is a timing chart for driving according to the third embodiment of the disclosed technology;

FIG. 7 is a structural diagram for the driving apparatus of the liquid crystal display according to a fourth embodiment of the disclosed technology; and

FIG. 8 is a timing chart for driving according to the fourth embodiment of the disclosed technology.

### DETAILED DESCRIPTION

Hereinafter, a clear and full description will be made to technical solutions of embodiments of disclosed technology in connection with the accompanying drawings of present embodiments. Apparently, rather than all the embodiments, embodiments to be described is only a part of embodiments of disclosed technology. Based on the embodiments of disclosed technology, all the other embodiments acquired by those skilled in the art without making creative work belong to the scope claimed by disclosed technology.

The inventor has found a driving apparatus for liquid crystal display according to the related arts at least has a question in that, since one output terminal correspondingly drives one data line or gate line, in a case where the number of output terminals for data driving ICs and gate driving ICs is up to a certain extent, a relatively large number of data driving ICs and gate driving ICs is required to be disposed, the number of the wirings on the PCB become large and routing therefor becomes complex, thus production cost is relatively high.

In an embodiment of the disclosed technology, there is provided a driving apparatus for a display and a driving method therefor, which can reduce the number of gate driving ICs and/or data driving ICs, whereby the number of the wirings for driving PCB on a circuit is reduced, and production cost is lowed.

The driving apparatus for a display provided by an embodiment of the disclosed technology include a gate line driving module array and/or a data line driving module array, in addition to a gate driver and a data driver.

The gate line driving module array comprises “A” gate line driving modules, each connected to one output terminal of the gate driver and two adjacent gate lines, the gate line driving module being used for driving the gate lines connected therewith to be sequentially turned on, where 1≦A≦M/2, A is an integral number and M represents a total number of rows of the gate lines.

The data line driving module array comprises “B” data line driving modules, each connected to one output terminal of the data driver and two adjacent data lines, the data line driving module being used for driving the data lines connected therewith to be sequentially turned on, where 1≦B≦N/2. B is an integral number, and N represents a total number of columns of the data lines.

In this embodiment, as shown in FIG. 1, each gate line driving module 4 includes a first thin film transistor 41 and a second thin film transistor 42. The gate of the first thin film transistor 41 is connected to an output terminal of a gate driving clock signal, the source thereof is connected to one output terminal of the gate driver, and the drain thereof is connected to one of the two adjacent gate lines 1. The gate of the second thin film transistor 42 is connected to the output terminal of the gate driving clock signal, the source thereof is connected to the one output terminal of the gate driver, and the drain thereof is connected to the other one of the two adjacent gate lines 1.

Each data line driving module 3 comprises a third thin film transistor 31 and a fourth thin film transistor 32. The gate of the third thin film transistor 31 is connected to an output terminal of a data driving clock signal, the source thereof is connected to one output terminal of the data driver, and the drain thereof is connected to one of the two adjacent data lines 2. The gate of the fourth thin film transistor 32 is connected to the output terminal of the data line driving clock signal, the source thereof is connected to the one output terminal of the data driver, and the drain thereof is connected to the other one of the two adjacent data lines.

In this embodiment, the first thin film transistor 41 is active (turned on) at high level, and the second thin film transistor 42 is active at low level; or, the first thin film transistor 41 is active at low level, and the second thin film transistor 42 is active at high level.

On the other hand, the third thin film transistor 31 is active at high level, and the fourth thin film transistor 32 is active at low level; or the third thin film transistor 31 is active at low level, and the fourth thin film transistor 32 is active at high level.

In the technical solution of this embodiment, with the gate line driving modules being each disposed between two rows of gate lines, and one gate line driving module being connected to one output terminal of the gate driver so as to constitute the gate line driving module array including a number of A/2 (1≦A≦M/2, M representing a total number of rows of the gate lines) gate line driving modules and thereby to enable one output terminal of the gate driving IC connected to the gate line driving module to carry out driving for two gate lines, and/or with the data line driving modules being each disposed between two rows of data lines, and one data line driving module being connected to one output terminal of the data driver so as to constitute the data line driving module array including a number of B/2 (1≦B≦N/2, N representing a total number of columns of the date lines) data line driving modules and thereby to enable one output terminal of the data driving IC connected to the data line driving module to carry out data output for two data lines, thus display of each frame of pictures in a panel is implemented. In this way, when the specification for output terminals of both the gate driving IC in the gate driver and the data driving IC in the data driver are unchanged, the required number of the gate driving IC and/or the data driving IC can be decreased without adverse influence on display frame frequency and reduced image quality. When one gate line driving module is disposed for every two gate lines and/or when one data line driving module is disposed for every two data lines, the number of the gate driving ICs and/or the data driving ICs is decreased by half, thus the number of the wirings on the PCB of the driving circuit and difficulty in layout of the PCB elements are reduced effectively, and in turn the area occupied by the PCB can be reduced, the cost become lower, and the display panel can become thinner and lighter.

Hereinafter, the technical solution of disclosed technology will be illustrated with specific embodiments.

### First Embodiment

This embodiment will be illustrated by taking the liquid crystal display as an example. In this embodiment, a gate line driving module array and a data line driving module array are adopted. Further, two gate lines connected to the gate line driving module include one gate line on one odd row and one gate line on one even row, and two data lines connected to the data line driving module include one data line on one odd column and one data line on one even column.

Specifically, as shown in FIG. 1, the adopted gate line driving module 4 includes a first thin film transistor 41 which is active at high level, and a second thin film transistor 42 which is active at low level. The gate of the first thin film transistor 41 is connected to an output terminal of a gate line driving clock signal, the source thereof is connected to one output terminal of the gate driver, and the drain thereof is connected to one of gate lines 1 on the odd row. The gate of the second thin film transistor 42 is connected to output terminal of the gate line driving clock signal, the source thereof is connected to one output terminal of the gate driver, and the drain thereof is connected to one of gate lines 1 on the even row.

The adopted data line driving module 3 includes a third thin film transistor 31 which is active at high level, and a fourth thin film transistor 32 which is active at low level. The gate of the third thin film transistor 31 is connected to an output terminal of a data line driving clock signal, the source thereof is connected to one output terminal of the data driver, and the drain thereof is connected to one of data lines 2 on the odd column. The gate of the fourth thin film transistor 32 is connected to output terminal of data line driving clock signal, the source thereof is connected to one output terminal of the data driver, and the drain thereof is connected to one of data lines 2 on the even column.

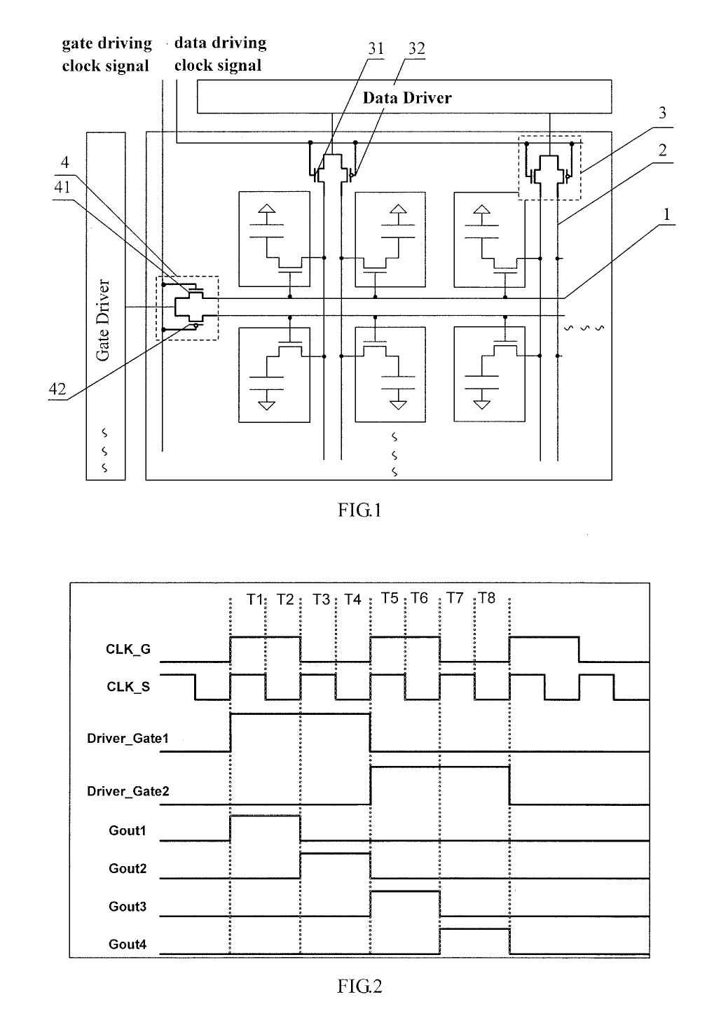

FIG. 2 shows a timing chart for driving according to the first embodiment of the disclosed technology. In FIG. 2, CLK-G represents a gate line driving clock signal, CLK-S represents a data line driving clock signal, Driver-Gate1 represents an output from a first output terminal of the gate driving IC. Driver-Gate2 represents an output from a second output terminal of the gate driving IC. Gout1 represents an output from a first row of gate line, Gout2 represents an output from a second row of gate line, Gout3 represents an output from a third row of gate line and Gout4 represents an output from a fourth row of gate line.

Specifically, as shown in FIG. 1, when the first output terminal Driver_Gate1 of the gate driving IC outputs a high level signal, operations of the two gate lines 1 connected to this terminal are as follows.

When CLK_G is at high level, the first thin film transistor 41 corresponding to one of the gate lines 1 on the odd row is active at high level, and the first thin film transistor 41 is turned on. That is, during the time periods of T1 and T2, the first row of the gate lines 1 is turned on. In time period of T1, CLK_S is at high level, and the third thin film transistor 31 is turned on since the third thin film transistor 31 is active at high level, thus data signals are written to the odd pixel units corresponding to the first row of the gate lines 1 by one of the data lines 2 on the odd column. In time period of T2, CLK_S is at low level, and the fourth thin film transistor 32 is turned on since the fourth thin film transistor 32 is active at low level, thus data signals are written to the even pixel units corresponding to the first row of the gate lines 1 by row of the gate lines 1 by one of the data lines 2 on the even column. Thereby, writing of the data signal to all pixel units of the first row is completed.

Next, when CLK_G is at low level, the second thin film transistor 42 corresponding to one of the gate lines 1 on the even row is active at low level, and the second thin film transistor 42 is turned on. That is, during time periods of T3 and T4, the second row of the gate lines 1 is turned on. In time period of T3, CLK_S is at high level, and the third thin film transistor 31 is turned on since the third thin film transistor 31 is active at high level, thus data signals are written to the odd pixel units corresponding to the second row of the gate lines 1 by one of the data lines 2 on the odd column. In time period of T4, CLK_S is at low level, and the fourth thin film transistor 32 is turned on since the fourth thin film transistor 32 is active at low level, thus data signals are written to the even pixel units corresponding to the second row of the gate lines 1 by one of the data lines 2 on the even column. Thereby, writing of the data signals to all pixel units of the second row is completed.

When the second output terminal Driver_Gate2 of the gate driving IC outputs a high level, operations of the two gate lines 1 connected to this terminal are as follows.

When CLK_G is at high level, the first thin film transistor 41 corresponding to one of the gate lines 1 on the odd row is active at high level, and the first thin film transistor 41 is turned on. That is, during time periods of T5 and T6, the third row of the gate lines 1 is turned on. In time period T5, CLK_S is at high level, and the third thin film transistor 31 is turned on since the third thin film transistor 31 is active at high level, thus data signals are written to the odd pixel units corresponding to the third row of the gate lines 1 by one of the data lines 2 on the odd column. In time period of T6, CLK_S is at low level, and the fourth thin film transistor 32 is turned on since the fourth thin film transistor 32 is active at low level, thus data signals are written to the even pixel units corresponding to the third row of the gate lines 1 by one of the data lines 2 on the even column. Thereby, writing of the data signals to all pixel units of the third row is completed.

When CLK_G is at low level, the second thin film transistor 42 corresponding to one of the gate lines 1 on the even row is active at low level, and the second thin film transistor 42 is turned on. That is, during time periods of T7 and T8, the fourth row of the gate lines 1 is turned on. In time period of T7, CLK_S is at high level, and the third thin film transistor 31 is turned on since the third thin film transistor 31 is active at high level, thus data signals are written to the odd pixel units corresponding to the fourth row of the gate lines 1 by one of the data lines 2 on the odd column. In time period of T8, CLK_S is at low level, and the fourth thin film transistor 32 is turned on since the fourth thin film transistor 32 is active at low level, thus data signals are written to the even pixel units corresponding to the fourth row of the gate lines 1 by one of the data lines 2 on the even column. Thereby, writing of the data signals to all pixel units of the fourth row is completed.

Similar to this, display for each frame of a picture can be completed.

In the technical solution of this embodiment, with the gate line driving modules being each disposed between one gate line on one odd row and one gate line on the next even row, one gate line driving module being connected to one output terminal of the gate driver so as to constitute the gate line driving module array including a number of A/2 (1≦A≦M/2, M representing a total number of rows of the gate lines) gate line driving modules and thereby to enable one output terminal of the gate driving IC connected to the gate line driving module to carry out a driving for two gate lines, and with the data line driving modules being each disposed between one data line on one odd column and one data line on the next even column, one data line driving module being connected to one output terminal of the data driver so as to constitute the data line driving module array including a number of B/2 (1≦B≦N/2, N representing a total number of columns of the date lines) data line driving modules and thereby to enable one output terminal of the data driving IC connected to the data line driving module to carry out data output for two data lines, display for each frame of a picture in a liquid crystal panel is completed. In this way, when the specification for output terminals of both the gate driving IC in the gate driver and the data driving IC in the data driver are unchanged, the required number of the gate driving IC and/or the data driving IC can be decreased without adverse influence on display frame frequency and reduced image quality. When one gate line driving module is disposed for every two gate lines and/or when one data line driving module is disposed for every two data lines, the number of the gate driving IC and/or the data driving IC is decreased by half, thus the number of the wirings for PCB of the driving circuit and difficulty in layout of PCB elements are reduced effectively, and in turn the area occupied by the PCB can be reduced, the cost become low, and the display panel ca become thinner and lighter.

### Second Embodiment

In this embodiment, a data line driving module array is disposed. Further, two data lines connected to the data line driving module include one data line on one odd column and one data line on one even column.

Specifically, FIG. 4 shows a timing chart for driving according to the second embodiment of the disclosed technology. In FIG. 4, CLK-S represents a data line driving clock signal, Driver-Gate1 represents an output from a first output terminal of the gate driving IC, Driver-Gate2 represents an output from a second output terminal of the gate driving IC, Gout1 represents an output from a first row of gate line. Gout2 represents an output from a second row of gate line, Gout3 represents an output from a third row of gate line, and Gout4 represents an output from a fourth row of gate line.

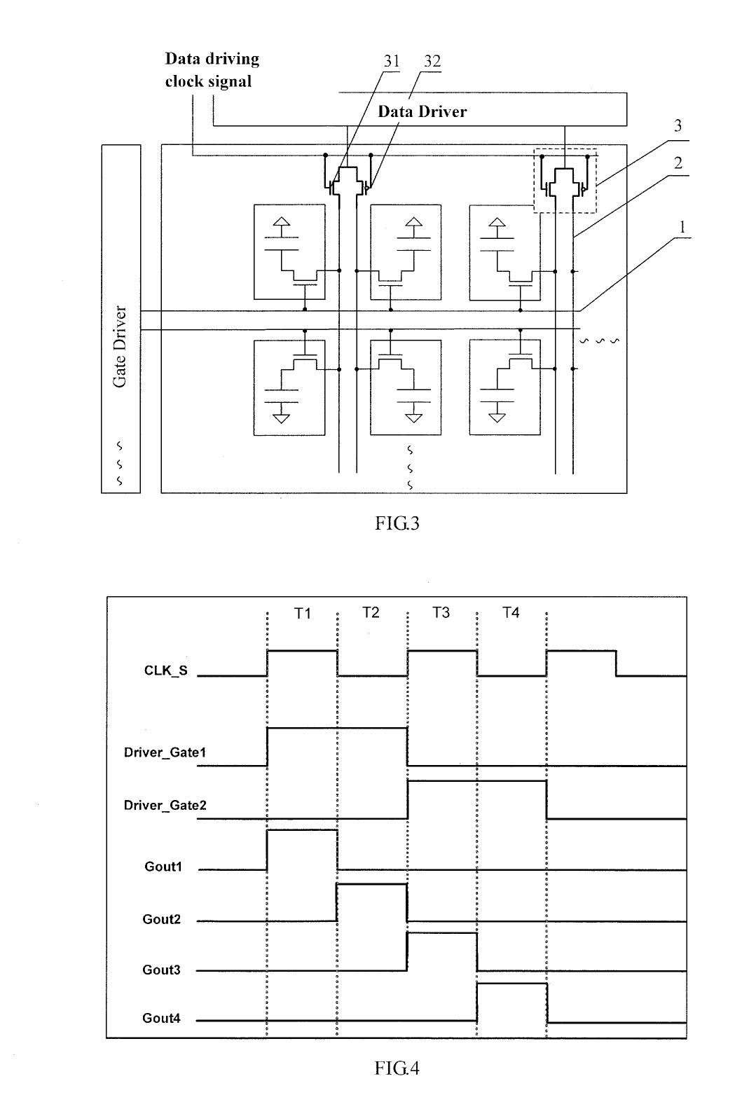

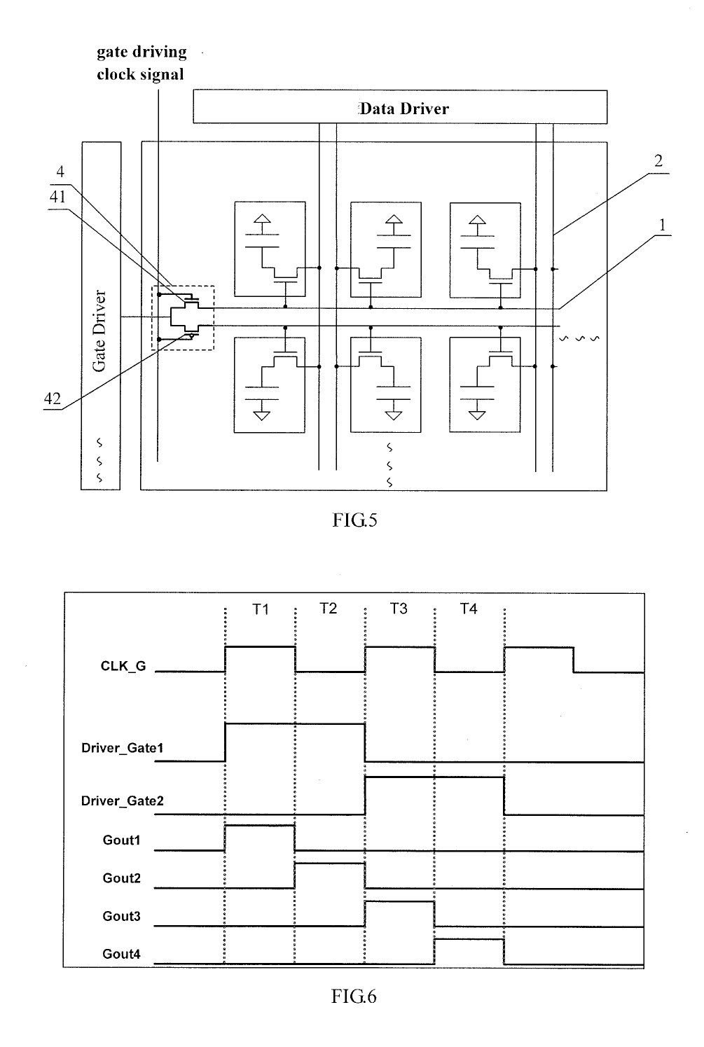

Specifically, a description will be made with reference to FIGS. 3 and 4.

During time periods of T1 and T2, the first output terminal Driver_Gate1 of the gate driving IC outputs a high level, and at this moment, the row of the gate lines 1 corresponding to first row of the gate lines 1 corresponding to the first output terminal Driver_Gate1 is turned on. During time period of T1, CLK_S is at high level, and the third thin film transistor 31 is turned on since the third thin film transistor 31 is active at high level, thus data signals are written to the odd pixel units corresponding to the first row of the gate lines 1 by one of the data lines 2 on the odd column. In time period of T2, CLK_S is at low level, and the fourth thin film transistor 32 is turned on since the fourth thin film transistor 32 is active at low level, thus data signals are written to the even pixel units corresponding to the first row of the gate lines 1 by one of the data lines 2 on the even column. Thereby, writing of the data signals to all pixel units of the first row is completed.

During time periods of T3 and T4, the second output terminal Driver_Gate2 of the gate driving IC outputs a high level, and at this moment, the second row of the gate lines 1 corresponding to the second output terminal Driver_Gate2 is turned on. During time period of T3, CLK_S is at high level, and the third thin film transistor 31 is turned on since the third thin film transistor 31 is active at high level, thus data signals are written to the odd pixel units corresponding to the second row of the gate lines 1 by one of the data lines 2 on the odd column. In time period of T4, CLK_S is at low level, and the fourth thin film transistor 32 is turned on since the fourth thin film transistor 32 is active at low level, thus data signals are written to the even pixel units corresponding to the second row of the gate lines 1 by one of the data lines 2 on the even column. Thereby, writing of the data signals to all pixel units of the second row is completed.

Similar to this, display for each frame of a picture can be completed.

In the technical solution of this embodiment, with the data line driving modules being each disposed between one gate line on one odd row and one gate line on the next even row, and one data line driving module being connected to one output terminal of the data driver so as to constitute the data line driving module array including a number of B/2 (1≦B≦N/2, N representing a total number of columns of the data lines) data line driving modules and thereby to enable one output terminal of the data driving IC connected to the data line driving module to carry out a driving for two data lines, display for each frame of a picture in a liquid crystal panel is completed. In this way, when the specification for output terminals of both the gate driving IC in the gate driver and the data driving IC in the data driver are unchanged, the required number of the gate driving IC can be decreased without adverse influence on display frame frequency and reduced image quality. When one data line driving module is disposed for every two data lines, the number of the data driving IC is decreased by half, thus the number of the wirings for PCB of the driving circuit and difficulty in layout of PCB elements are reduced effectively, and in turn the area occupied by the PCB can be reduced, the cost become low, and the display panel can become thinner and lighter.

### Third Embodiment

In this embodiment, a gate line driving module array is provided. Further, two gate lines connected to the gate line driving module include one gate line on one odd row and one gate line on one even row.

Specifically, FIG. 6 shows a timing chart for driving according to the third embodiment of the disclosed technology. In FIG. 6, CLK-G represents a gate line driving clock signal, Driver-Gate1 represents an output from a first output terminal of the gate driving IC, Goutl represents an output from a first row of gate line, Gout2 represents an output from a second row of gate line, Gout3 represents an output from a third row of gate line, and Gout4 represents an output from a fourth row of gate line.

Specifically, as shown in FIG. 6, when the first output terminal DriverGate1 of the gate driving IC outputs a high level, operations of the two gate lines 1 connected to this terminal are as follows.

In time period of T1, when CLK_G is at high level, the first thin film transistor 41 corresponding to one of the gate lines 1 on the odd row is active at high level, and the first thin film transistor 41 is turned on. That is, in time period of T1, the first row of the gate lines 1 is turned on, and data signals are written to the pixel units corresponding to the first row of the gate lines 1 by the data lines 2.

In time period of T2, when CLK_G is at low level, the second thin film transistor 42 corresponding to one of the gate lines 1 on the odd row is active at low level, and the second thin film transistor 42 is turned on. That is, in time period of T2, the second row of the gate lines 1 is turned on, and data signals are written to the pixel units corresponding to the second row of the gate lines 1 by the data lines 2.

When the second output terminal Driver_Gate2 of the gate driving IC outputs a high level, operations are as follows.

In time period of T3, when CLK_G is at high level, the first thin film transistor 41 corresponding to one of the gate lines 1 on the odd row is active at high level, and the first thin film transistor 41 is turned on. That is, in time period of T3, the third row of the gate lines 1 is turned on, and data signals are written to the pixel units corresponding to the third row of the gate lines 1 by the data lines 2.

In time period of T4, when CLK_G is at low level, the second thin film transistor 42 corresponding to one of the gate lines 1 on the even row is active at low level, and the second thin film transistor 42 is turned on. That is, in time period of T4, the fourth row of the gate lines 1 is turned on, and data signals are written to the pixel units corresponding to the fourth row of the gate lines 1 by the data lines 2.

Similar to this, display for each frame of a picture can be completed.

In the technical solution of this embodiment, with the gate line driving modules being each disposed between one gate line on one odd row and one gate line on the next even row, one gate line driving module being connected to one output terminal of the gate driver so as to constitute the gate line driving module array including a number of A/2 (1≦A≦M/2, M representing a total number of rows of the gate lines) gate line driving modules and thereby to enable one output terminal of the gate driving IC connected to the gate line driving module to carry out a driving for two gate lines, display for each frame of a picture in a liquid crystal panel is completed. when the specification for output terminals of both the gate driving IC in the gate driver and the data driving 1C in the data driver are unchanged, the required number of the data driving IC can be decreased without adverse influence on display frame frequency and reduced image quality. When one gate line driving module is disposed for every two gate lines, the number of the gate driving IC is decreased by half, thus the number of the wirings for PCB of the driving circuit and difficulty in layout of PCB elements are reduced effectively, and in turn the area occupied by the PCB can be reduced, the cost become low, and the display panel ca become thinner and lighter.

### Fourth Embodiment

In this embodiment, a gate line driving module array and a data line driving module array are disposed. Different from the first embodiment, the adopted gate line driving module 4 includes a first thin film transistor 41 which is active at low level, and a second thin film transistor 42 which is active at high level. The gate of the first thin film transistor 41 is connected to an output terminal of a gate line driving clock signal, the source thereof is connected to one output terminal of the gate driver, and the drain thereof is connected to one of gate lines 1 on the odd row. The gate of the second thin film transistor 42 is connected to output terminal of the gate line driving clock signal, the source thereof is connected to one output terminal of the gate driver, and the drain thereof is connected to one of gate lines 1 on the even row. 100631 The adopted data line driving module 3 includes a third thin film transistor 31 which is active at low level, and a fourth thin film transistor 32 which is active at high level. The gate of the thin film transistor 31 is connected to an output terminal of a data line driving clock signal, the source thereof is connected to one output terminal of the data driver, and the drain thereof is connected to one of data lines 2 on the odd column. The gate of the fourth thin film transistor 32 is connected to output terminal of the data line driving clock signal, the source thereof is connected to one output terminal of the data driver, and the drain thereof is connected to one of data lines 2 on the even column.

Specifically, FIG. 8 shows a timing chart for driving according to the fourth embodiment of the disclosed technology. In FIG. 8, CLK-G represents a gate line driving clock signal, CLK-S represents a data line driving clock signal, Driver-Gate1 represents an output from a first output terminal of the gate driving IC, Driver-Gate2 represents an output from a second output terminal of the gate driving IC, Goutl represents an output from a first row of gate line. Gout2 represents an output from a second row of gate line, Gout3 represents an output from a third row of gate line and Gout4 represents an output from a fourth row of gate line.

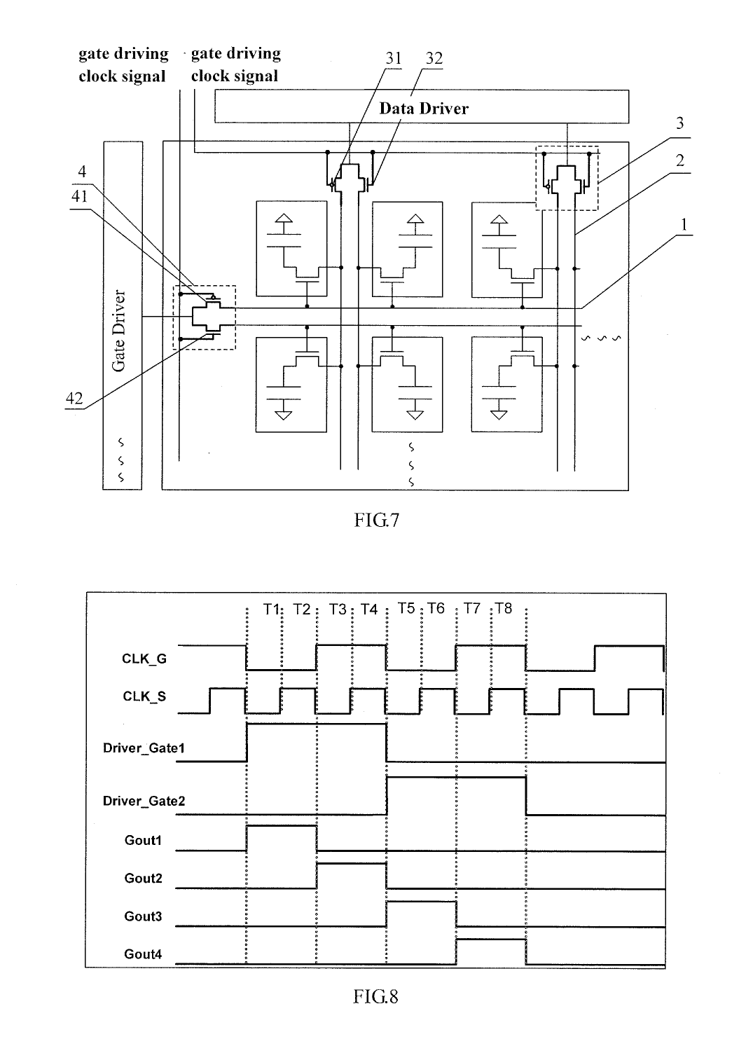

Specifically, as shown in FIGS. 7 and 8, when the first output terminal Driver_Gate1 of the gate driving IC outputs a high level, operations of the two gate lines 1 connected to this terminal are as follows.

When CLK_G is at low level, the first thin film transistor 41 corresponding to one of the gate lines 1 on the odd row is active at low level, and the first thin film transistor 41 is turned on. That is, during time periods of T1 and T2, the first row of the gate lines 1 is turned on. In time period of T1, CLK_S is at low level, and the third thin film transistor 31 is turned on since the third thin film transistor 31 is active at low level, thus data signals are written to the odd pixel units corresponding to the first row of the gate lines 1 by one of the data lines 2 on the odd column. In time period of T2, CLK_S is at high level, and the fourth thin film transistor 32 is turned on since the fourth thin film transistor 32 is active at high level, thus data signals are written to the even pixel units corresponding to the first row of the gate lines 1 by one of the data lines 2 on the even column. Thereby, writing of the data signals to all pixel units of the first row is completed.

When CLK_G is at high level, the second thin film transistor 42 corresponding to one of the gate lines 1 on the even row is active at high level, and the second thin film transistor 42 is turned on. That is, during periods of T3 and T4, the second row of the gate lines 1 is turned on. In time period of T3, CLK_S is at low level, and the third thin film transistor 31 is turned on since the third thin film transistor 31 is active at low level, thus data signals are written to the odd pixel units corresponding to the second row of the gate lines 1 by one of the data lines 2 on the odd column. In time period of T4, CLK_S is at high level, and the fourth thin film transistor 32 is turned on since the fourth thin film transistor 32 is active at high level, thus data signals are written to the even pixel units corresponding to the second row of the gate lines 1 by one of the data lines 2 on the even column. Thereby, writing of the data signals to all pixel units of the second row is completed.

When the second output terminal Driver Date2 of the gate driving IC outputs a high level, operations of the two gate lines 1 connected to this terminal are as follows.

When CLKG is at low level, the first thin film transistor 41 corresponding to one of the gate lines 1 on the odd row is active at low level, and the first thin film transistor 41 is turned on. That is, during time periods of T5 and T6, the third row of the gate lines 1 is turned on. In time period of T5, CLK_S is at low level, and the third thin film transistor 31 is turned on since the third thin film transistor 31 is active at low level, thus data signals are written to the odd pixel units corresponding to the third row of the gate lines 1 by one of the data lines 2 on the odd column. In time period of T6, CLK_S is at high level, and the fourth thin film transistor 32 is turned on since the fourth thin film transistor 32 is active at high level, thus data signals are written to the even pixel units corresponding to the third row of the gate lines 1 by one of the data lines 2 on the even column. Thereby, writing of the data signals to all pixel units of the third row is completed.

When CLK_G is at high level, the second thin film transistor 42 corresponding to one of the gate lines 1 on the even row is active at high level, and the second thin film transistor 42 is turned on. That is, during time periods of T7 and T8, the fourth row of the gate lines 1 is turned on. In time period of T7, CLK_S is at low level, and the third thin film transistor 31 is turned on since the third thin film transistor 31 is active at low level, thus data signals are written to the odd pixel units corresponding to the fourth row of the gate lines 1 by one of the data lines 2 on the odd column. In time period of T8, CLK_S is at high level, and the fourth thin film transistor 32 is turned on since the fourth thin film transistor 32 is active at high level, thus data signals are written to the even pixel units corresponding to the fourth row of the gate lines 1 by one of the data lines 2 on the even column. Thereby, writing of the data signals to all pixel units of the fourth row is completed.

Similar to this, display for each frame of a picture can be completed.

In the technical solution of this embodiment, with the gate line driving modules being each disposed between one gate line on one odd row and one gate line on the next even row, one gate line driving module being connected to one output terminal of the gate driver so as to constitute the gate line driving module array including a number of A/2 (1≦A≦M/2, M representing a total number of rows of the gate lines) gate line driving modules and thereby to enable one output terminal of the gate driving IC connected to the gate line driving module to carry out a driving for two gate lines, and with the data line driving modules being each disposed between one data line on one odd column and one data line on the next even column, one data line driving module being connected to one output terminal of the data driver so as to constitute the data line driving module array including a number of B/2 (1≦B≦N/2, N representing a total number of columns of the date lines) data line driving modules and thereby to enable one output terminal of the data driving IC connected to the data line driving module to carry out data output for two data lines, display for each frame of a picture in a liquid crystal panel is completed. In this way, when the specification for output terminals of both the gate driving IC in the gate driver and the data driving IC in the data driver are unchanged, the required number of the gate driving IC and/or the data driving IC can be decreased without adverse influence on display frame frequency and reduced image quality. When one gate line driving module is disposed for every two gate lines and/or when one data line driving module is disposed for every two data lines, the number of the gate driving IC and/or the data driving IC is decreased by half, thus the number of the wirings for PCB of the driving circuit and difficulty in layout of PCB elements are reduced effectively, and in turn the area occupied by the PCB can be reduced, the cost become low, and the display panel ca become thinner and lighter.

Preferably, in the above embodiments, the gate lines connected to the gate line driving module include one gate line on one odd row and one gate line on the next even row adjacent to each other, and/or the data lines connected to the data line driving module include one data line on one odd column and one data line on the next even column adjacent to each other. For such a structure, the way of routing is simple, the overlap among lines can be avoided, and also it is easy for implementing.

It should be noted that, the arrange mode for pixels of the liquid crystal panel provided by embodiments of the disclosed technology can adopt various form and not limited to the above embodiments. Also, the gate driving mode can be variously selected and not limited to the way of gate driving IC, and it is also possible to adopt driving modes such as COG (Chip On Glass), GOA (Gate On Array), and the like. For a case in which GOA is adopted, the advantage thereof is that the number of level conversion units for row driving is decreased by half.

### Fifth Embodiment

The embodiment of disclosed technology also provides a driving method for a liquid crystal display according to one of the above-described embodiments, wherein the data lines of the display are divided into a plurality of groups with every two data lines being in one group, and the method comprises:

step 101 of during a first time period when each of the gate lines is turned on, one of two adjacent data lines in each of the groups of data lines are turned on simultaneously;

step 102 of during a second time period when each of the gate lines is turned on, the other one of two adjacent data lines in each of the groups of data lines are turned on simultaneously.

Further, in a case where the two adjacent data lines in each of the groups of data lines include one data line on one odd column and one data line on one even column, the method includes step 201 of during a first time period when each of the gate lines is turned on, the data lines on odd column are turned on simultaneously, and data signals are displayed by odd pixel units corresponding to the gate line simultaneously; or the data lines on even column are turned on simultaneously, and data signals are displayed by even pixel units corresponding to the gate line simultaneously; and step 202 of during a second time period when each of the gate lines is turned on, the data lines on even column are turned on simultaneously, and data signals are displayed by even pixel units corresponding to the gate line simultaneously; or the data lines on odd column are turned on simultaneously, and data signals are displayed by odd pixel units corresponding to the gate line simultaneously.

In the embodiment according to the above method, it is assumed that the total time for turning on of each of gate lines is T, a first time period is Ta, and a second period is /Tb, then a relation of Ta=Tb=T/2 exists. That is, during a time period T when the gate line is turned on, the data lines on odd columns and the data lines on even columns are turned on in time period of Ta or Tb respectively, and thereby data display for pixel units corresponding to full row of gate line is completed.

It should be noted that, the turning on of the gate lines can be performed row by row, and also can be sequentially performed according to a sequence set in advance, thus it is not limited thereto.

The above embodiments have been illustrated with the liquid crystal display as an example. However, it can be understood by those skilled in the art that, the implementation thereof can be applied to other types of displays such as organic light emission display (OLED), light emission diode (LED) display, plasma display (PDP) and the like.

With description in the above embodiments, those skilled in the art can recognize that the disclosed technology can be implemented by means of software, essential general purpose hardware, or firmware. Of course, the disclosed technology can be implemented by hardware, although the former is the common implantation in many cases. Based on such comprehension, the essential of technical solution of the disclosed technology, or a part thereof contributing to the related arts. can be embodied in a software product. The software product can be stored in a readable storage medium such as floppy disk, hardware or optical disk or the like in a computer, and can include several instructions to enable a computer device, which can be personal computer, server or network device and the like, to execute the method described in respective embodiments of the disclosed technology.

The above description is merely specific embodiments of the disclosed technology, and protection scope of the disclosed technology is not limited thereto. Within the technical scope disclosed by the disclosed technology, any one familiar with this art can easily conceive of variations and alternations, and these should be encompassed into the protection scope of the disclosed technology. Therefore, the protection scope of the disclosed technology should be determined by the protection scope of the claims.

What is claimed is:

1. A driving apparatus for a display, comprising:
a gate driver;
a data driver; and
a gate line driving module array and/or a data line driving module array, wherein,
the gate line driving module array comprises “A” gate line driving modules, each connected to one output terminal of the gate driver and two gate lines and adapted for driving the gate lines connected therewith to sequentially turn on, where 1≦A≦M/2, A is an integral number, and M represents a total number of rows of the gate lines.

2. The driving apparatus according to claim 1, wherein,
each gate line driving module comprises a first thin film transistor and a second thin film transistor, and wherein
a gate of the first thin film transistor is connected to an output terminal of a gate driving clock signal, a source thereof is connected to the one output teiminal of the gate driver, and a drain thereof is connected to one of the two gate lines, and
a gate of the second thin film transistor is connected to the output terminal of the gate driving clock signal, a source thereof is connected to the one output terminal of the gate driver, and a drain thereof is connected to the other one of the two gate lines.

3. The driving apparatus according to claim 2, wherein,
the first thin film transistor is active at high level, and the second thin film transistor is active at low level; or
the first thin film transistor is active at low level, and the second thin film transistor is active at high level.

4. The driving apparatus according to claim 1, wherein, the data line driving module array comprises “B” data line driving modules, each connected to one output terminal of the data driver and two data lines and adapted for driving the data lines connected therewith, where 1≦B≦N/2, B is an integral number, and N represents a total number of columns of the data lines.

5. The driving apparatus according to claim 2, wherein,
the data line driving module array comprises “B” data line driving modules, each connected to one output terminal of the data driver and two data lines and adapted for driving the data lines connected therewith, where 1≦B≦N/2, B is an integral number, and N represents a total number of columns of the data lines.

6. The driving apparatus according to claim 5, wherein,
each data line driving module comprises a third thin film transistor and a fourth thin film transistor, and wherein
a gate of the third thin film transistor is connected to an output terminal of a data line driving clock signal, a source thereof is connected to the one output terminal of the data driver, and a drain thereof is connected to one of the two data lines, and
a gate of the fourth thin film transistor is connected to the output terminal of the data line driving clock signal, a source thereof is connected to the one output terminal of the data driver, and a drain thereof is connected to the other one of the two data lines.

7. The driving apparatus according to claim 6, wherein,
the third thin film transistor is active at high level, and the fourth thin film transistor is active at low level; or
the third thin film transistor is active at low level, and the fourth thin film transistor is active at high level.

8. The driving apparatus according to claim 5, wherein,
the two gate lines connected to each gate line driving module include one gate line on one odd row and one gate line on one even row.

9. The driving apparatus according to claim 8, wherein,
the two gate lines connected to each gate line driving module include one gate line on one odd row and one gate line on one even row sequentially adjacent to each other.

10. The driving apparatus according to claim 5, wherein,
the two data lines connected to the data line driving module include one data line on one odd column and one data line on one even column.

11. The driving apparatus according to claim 10, wherein,
the two data lines connected to the data line driving module include one data line on one odd column and one data line on one even column sequentially adjacent to each other.

12. The driving apparatus according to claim 8, wherein,
the two data lines connected to the data line driving module include one data line on one odd column and one data line on one even column.

13. A liquid crystal display, comprising the driving apparatus according to claim 1.

14. A driving method for a display, comprising:
dividing data lines of the display into a plurality of groups with every two data lines being in one group;
during a first time period when each of the gate lines is turned on, one of the two data lines in each of the groups of data lines are turned on simultaneously; and
during a second time period when each of the gate lines is turned on, the other one of the two data lines in each of the groups of data lines are turned on simultaneously.

15. The method according to claim 14, wherein,
the two data lines in each of the groups of data lines include one data line on one odd column and one data line on one even column, and
during a first time period when each of the gate lines is turned on,
the data lines on odd column are turned on simultaneously, and data signals are displayed by odd pixel units corresponding to the gate line simultaneously; or the data lines on even column are turned on simultaneously, and data signals are displayed by even pixel units corresponding to the gate line simultaneously; and
during a second time period when each of the gate lines is turned on,
the data lines on even column are turned on simultaneously, and data signals are displayed by even pixel units corresponding to the gate line simultaneously; or the data lines on odd column are turned on simultaneously, and data signals are displayed by odd pixel units corresponding to the gate line simultaneously.
